(19) United States
(12) Patent Application Publication
(10) Pub. No.: US 2014/0261949 A1
(43) Pub. Date: Sep. 18, 2014

(54) TIRE HAVING A SPLIT BODY PLY CONSTRUCTION

(71) Applicant: BRIDGESTONE AMERICAS TIRE OPERATIONS, LLC, Nashville, TN (US)

(72) Inventors: Anthony R. Marella, Tallmadge, OH (US); Jacob L. Walters, Medina, OH (US); Kathleen A. Clemmer, Akron, OH (US); Jon I. Stuckey, Louisville, OH (US); Kent D. Weatherwax, Akron, OH (US); Richard J. Wright, Wadsworth, OH (US); Shawn L. Copeland, Wadsworth, OH (US); Justin M. Gehres, Uniontown, OH (US); Makameh M. Salehi, Stow, OH (US); John J. Norwood, Wadsworth, OH (US)

(73) Assignee: BRIDGESTONE AMERICAS TIRE OPERATIONS, LLC, Nashville, TN (US)

(21) Appl. No.: 13/832,501

(22) Filed: Mar. 15, 2013

(51) Int. Cl. B60C 9/02

(52) U.S. Cl. CPC B60C 9/0207
USPC 152/526

(57) ABSTRACT

Various embodiments of a tire having a split body ply construction are disclosed.

### BACKGROUND

In the construction of a tire, one of the many key elements is the body ply. The body ply, which typically comprises reinforcement cord and rubber skim, wraps around the bead wire bundle (creating a “turnup” portion), passes radially across the tire, and wraps around the bead bundle on the opposite side (creating another “turnup” portion). The body ply provides strength to contain the air pressure within the tire and provides for sidewall impact resistance.

A prevalent consideration in the tire industry is the increasing of fuel efficiency through tire design. One strategy for increasing fuel efficiency through tire design is reducing the weight of the tire. Likewise, reduction of the materials used in tire construction would conserve natural resources.

What is needed is a reduced-weight tire and a method for making the same.

### SUMMARY

In one embodiment, a pneumatic tire is provided, the pneumatic tire comprising: at least one belt oriented in a crown portion of the tire, the at least one belt comprising a first belt edge and a second belt edge; a first bead portion; a second bead portion; a first sidewall; a second sidewall; a first fiber-reinforced half body ply extending about the first bead portion, along the first sidewall, and terminating inside of the first belt edge; a second fiber-reinforced half body ply extending about the second bead portion, along the second sidewall, and terminating inside of the second belt edge; and a cut-out zone in the crown portion of the tire, with the caveat that no fiber-reinforced material extends through the cut-out zone.

In another embodiment, a pneumatic tire is provided, the pneumatic tire comprising: at least one belt oriented in a crown portion of the tire, the at least one belt comprising a first belt edge and a second belt edge; a first bead portion; a second bead portion; a first sidewall; a second sidewall; a first fiber-reinforced half body ply extending about the first bead portion, along the first sidewall, and terminating inside of the first belt edge; a second fiber-reinforced half body ply extending about the second bead portion, along the second sidewall, and terminating inside of the second belt edge; a third fiber-reinforced half body ply extending from above the first bead portion, along the first sidewall, and terminating inside of the first belt edge; and a fourth fiber-reinforced half body ply extending from above the second bead portion, along the second sidewall, and terminating inside of the second belt edge.

In another embodiment, a pneumatic tire is provided, the pneumatic tire comprising: at least one belt oriented in a crown portion of the tire, the at least one belt comprising a first belt edge and a second belt edge; a first bead portion; a second bead portion; a first sidewall; a second sidewall; a first fiber-reinforced half body ply extending from inside of the first belt edge, along the first sidewall, about the first bead portion, along the first sidewall, and terminating inside of the first belt edge; a second fiber-reinforced half body ply extending from inside of the second belt edge, along the second sidewall, about the second bead portion, along the second sidewall, and terminating inside of the second belt edge; and a cut-out zone in the crown portion of the tire, with the caveat that no fiber-reinforced material extends through the cut-out zone.

### BRIEF DESCRIPTION OF THE DRAWINGS

The accompanying figures, which are incorporated in and constitute a part of the specification, illustrate various example apparatuses and systems, and are used merely to illustrate various example embodiments. In the figures, like elements bear like reference numerals.

FIG. 1 illustrates a cross-sectional view of an example arrangement of a tire having a split body ply construction.

FIG. 2 illustrates a cross-sectional view of an example arrangement of a tire having a split body ply construction.

FIG. 3 illustrates a cross-sectional view of an example arrangement of a tire having a split body ply construction.

FIG. 4 illustrates a cross-sectional view of a prior art tire construction.

### DETAILED DESCRIPTION

The body ply of a tire radially inwardly of the belt in the crown portion carries relatively little to no force from the inflation pressure of the tire. As a result, any reinforcement provided by the body ply in this region is effectively unnecessary to the function of the tire. A tire void of body ply reinforcement in the crown portion would have less weight, and require less body ply material, than prior art tire constructions.

FIG. 1 illustrates a cross-sectional view of an example arrangement of a tire 100 having a split body ply construction. Tire 100 may comprise a first sidewall 105, a second sidewall 110, a crown portion 115, a first bead portion 120, and a second bead portion 125. Tire 100 may additionally comprise a first side 130 and a second side 135.

Tire 100 may comprise a pneumatic tire. In one embodiment, tire 100 is a pneumatic tire designed for application to a vehicle. In another embodiment, tire 100 is a pneumatic tire designed for application to a road vehicle. In one embodiment, tire 100 is a non-directional tire, wherein tire 100 is configured to be mounted on a vehicle without a specified forward rolling direction. In another embodiment, tire 100 is a uni-directional tire, wherein tire 100 is configured to be mounted on a vehicle with a specified forward rolling direction.

In one embodiment, tire 100 comprises at least one body ply. In another embodiment, tire 100 comprises at least one fiber-reinforced body ply. In another embodiment, tire 100 comprises at least one fiber-reinforced half body ply. In one embodiment, tire 100 comprises a first fiber-reinforced half body ply 140 and a second fiber-reinforced half body ply 145. First fiber-reinforced half body ply 140 and second fiber-reinforced half body ply 145 may comprise a reinforcement cord and rubber skim. In one embodiment, the reinforcement cord is a fiber reinforcement cord. In another embodiment, the reinforcement cord can be any of a variety of materials, including for example, polyester, rayon, nylon, aramid, and polyethylene naphthalate (PEN). In one embodiment, the rubber skim is any of a variety of rubber materials, having any of a variety of common formulations, densities, and other properties for use in tires.

In one embodiment, tire 100 comprises a belt 150. In another embodiment, tire 100 comprises a plurality of belts 150. Belt 150 may be oriented in crown portion 115 of tire 100. Crown portion 115 may be defined as the radially outermost portion of tire 100, extending generally between first sidewall 105 and second sidewall 110. Belt 150 may comprise any of a variety of materials, including a metal. In one embodiment, belt 150 comprises a first belt edge 155 and a second belt edge 160.

In one embodiment, first fiber-reinforced half body ply 140 extends about first bead portion 120, along first sidewall 105 and terminating inside (“inside” being toward the centerline CL of tire 100) of first belt edge 155. In another embodiment, first fiber-reinforced half body ply 140 extends from a point in first bead portion 120. In another embodiment, first fiber-reinforced half body ply 140 extends from a point in first sidewall 105. In another embodiment, first fiber-reinforced half body ply 140 extends from a point in the shoulder region of first side 130 of tire 100. In another embodiment, first fiber-reinforced half body ply 140 extends from inside first belt edge 155 of tire 100.

In one embodiment, second fiber-reinforced half body ply 145 extends about second bead portion 125, along second sidewall 110 and terminating inside (“inside” being toward the centerline CL of tire 100) of second belt edge 160. In another embodiment, second fiber-reinforced half body ply 145 extends from a point in second bead portion 125. In another embodiment, second fiber-reinforced half body ply 145 extends from a point in second sidewall 110. In another embodiment, second fiber-reinforced half body ply 145 extends from a point in the shoulder region of second side 135 of tire 100. In another embodiment, second fiber-reinforced half body ply 145 extends from inside second belt edge 160 of tire 100.

In one embodiment, first fiber-reinforced half body ply 140 comprises a first turnup portion 165 defined by the portion of first fiber-reinforced half body ply 140 extending about first bead portion 120. In another embodiment, second fiber-reinforced half body ply 145 comprises a second turnup portion 170 defined by the portion of second fiber-reinforced half body ply 145 extending about second bead portion 125.

In one embodiment, tire 100 comprises a centerline CL oriented at the laterally central point within tire 100. Centerline CL may correspond with the centerline of a rim.

In one embodiment, first fiber-reinforced half body ply 140 terminates at a point that is a distance D1 from centerline CL. In another embodiment, second fiber-reinforced half body ply 145 terminates at a point that is a distance D2 from centerline CL.

In one embodiment, tire 100 comprises a cut-out zone in crown portion 115. In one embodiment, no fiber-reinforced material extends through the cut-out zone, including any body ply or reinforcing ply. In another embodiment, no reinforcement material extends through the cut-out zone. The phrase “cut-out zone” is used herein to mean the zone in crown potion 115 between the end points of first fiber-reinforced half body ply 140 and second fiber-reinforced half body ply 145. The cut-out zone may have a width comprising the sum of distance D1 and distance D2.

In one embodiment, first belt edge 155 extends to a distance B1 from centerline CL. In another embodiment, second belt edge 160 extends to a distance B2 from centerline CL.

At least one of first fiber-reinforced half body ply 140 and second fiber-reinforced half body ply 145 may underlap belt 150. In one embodiment, distance B1 is greater than the distance D1. In another embodiment, distance B2 is greater than the distance D2. In one embodiment, distance B1 and distance B2 are between about 0.0 in. and about 3.0 in. greater than distance D1 and distance D2, respectively. In another embodiment, distance B1 and distance B2 are between about 0.2 in. and about 2.0 in. greater than distance D1 and distance D2, respectively. In another embodiment, distance B1 and distance B2 are between about 0.3 in. and about 1.0 in. greater than distance D1 and distance D2, respectively.

In one embodiment, at least one of first fiber-reinforced half body ply 140 and second fiber-reinforced half body ply 145 is oriented radially inwardly of belt 150. In another embodiment, both of first fiber-reinforced half body ply 140 and second fiber-reinforced half body ply 145 are oriented radially inwardly of belt 150. In another embodiment, at least one of first fiber-reinforced half body ply 140 and second fiber-reinforced half body ply 145 is oriented radially outwardly of belt 150.

In one embodiment, tire 100 comprises a third fiber-reinforced half body ply (not shown) extending about first bead portion 120, along first sidewall 105, and terminating inside first belt edge 155. In another embodiment, tire 100 comprises a fourth fiber-reinforced half body ply (not shown) extending about second bead portion 120, along second sidewall 110, and terminating inside second belt edge 160. In another embodiment, tire 100 comprises fiber-reinforced half body plies in addition to the third and fourth fiber-reinforced half body plies.

In one embodiment, tire 100 comprises at least one body ply beginning in first side 130, extending across crown portion 115, and terminating in second side 135. The at least one body ply may extend about one or both of first bead portion 120 and second bead portion 125.

FIG. 2 illustrates a cross-sectional view of an example arrangement of a tire 200 having a split body ply construction. Tire 200 may comprise a first sidewall 205, a second sidewall 210, a crown portion 215, a first bead portion 220, and a second bead portion 225. Tire 200 may additionally comprise a first side 230 and a second side 235.

In one embodiment, tire 200 comprises at least one body ply. In another embodiment, tire 200 comprises at least one fiber-reinforced body ply. In another embodiment, tire 200 comprises at least one fiber-reinforced half body ply. In one embodiment, tire 200 comprises a first fiber-reinforced half body ply 240 and a second fiber-reinforced half body ply 245. First fiber-reinforced half body ply 240 and second fiber-reinforced half body ply 245 may comprise a reinforcement cord and rubber skim.

In one embodiment, tire 200 comprises a belt 250. In another embodiment, tire 200 comprises a plurality of belts 250. Belt 250 may be oriented in crown portion 215 of tire 200. In one embodiment, belt 250 comprises a first belt edge 255 and a second belt edge 260.

In one embodiment, first fiber-reinforced half body ply 240 extends from inside of first belt edge 255, along first sidewall 205, about first bead portion 220, along first sidewall 205, and terminating inside of first belt edge 255. In another embodiment, second fiber-reinforced half body ply 245 extends from inside of second belt edge 260, along second sidewall 210, about second bead portion 225, along second sidewall 210, and terminating inside of second belt edge 260. In one embodiment, a third fiber-reinforced half body ply (not shown) extends from inside of first belt edge 255, along first sidewall 205, about first bead portion 220, along first sidewall 205, and terminating inside of first belt edge 255. In another embodiment, a fourth fiber-reinforced half body ply (not shown) extends from inside of second belt edge 260, along second sidewall 210, about second bead portion 225, along second sidewall 210, and terminating inside of second belt edge 260.

In one embodiment, tire 200 comprises at least one body ply beginning in first side 230, extending across crown portion 215, and terminating in second side 235. The at least one body ply may extend about one or both of first bead portion 220 and second bead portion 225. In one embodiment, tire 200 comprises a third fiber-reinforced half body ply (not shown) extending about first bead portion 220, along first sidewall 205, and terminating inside of first belt edge 255. In another embodiment, tire 200 comprises a fourth fiber-reinforced half body ply (not shown) extending about second bead portion 220, along first sidewall 205, and terminating inside of first belt edge 255.

In one embodiment, first fiber-reinforced half body ply 240 comprises a first turnup portion 265 defined by the portion of first fiber-reinforced half body ply 240 extending about first bead portion 220. In another embodiment, second fiber-reinforced half body ply 245 comprises a second turnup portion 270 defined by the portion of second fiber-reinforced half body ply 245 extending about second bead portion 225.

In one embodiment, tire 200 comprises a centerline CL oriented at the laterally central point within tire 200. Centerline CL may correspond with the centerline of a rim.

In one embodiment, first fiber-reinforced half body ply 240 at least one of begins and terminates at a point that is a distance D1 from centerline CL. In another embodiment, second fiber-reinforced half body ply 245 at least one of begins and terminates at a point that is a distance D2 from centerline CL. In one embodiment, first belt edge 255 extends to a distance B1 from centerline CL. In another embodiment, second belt edge 260 extends to a distance B2 from centerline CL. In one embodiment, distance B1 and distance B2 are greater than distance D1 and distance D2.

In one embodiment, first fiber-reinforced half body ply 240 is oriented radially inwardly of belt 250. In one embodiment, second fiber-reinforced half body ply 245 is oriented radially inwardly of belt 250.

In one embodiment, tire 200 comprises a cut-out zone in crown portion 215. In one embodiment, no fiber-reinforced material extends through the cut-out zone, including any body ply or reinforcing ply. In another embodiment, no reinforcement material extends through the cut-out zone.

FIG. 3 illustrates a cross-sectional view of an example arrangement of a tire 300 having a split body ply construction. Tire 300 may comprise a first sidewall 305, a second sidewall 310, a crown portion 315, a first bead portion 320, and a second bead portion 325. Tire 300 may additionally comprise a first side 330 and a second side 335.

In one embodiment, tire 300 comprises at least one body ply. In another embodiment, tire 300 comprises at least one fiber-reinforced body ply. In another embodiment, tire 300 comprises at least one fiber-reinforced half body ply. In one embodiment, tire 300 comprises a first fiber-reinforced half body ply 340 and a second fiber-reinforced half body ply 345. First fiber-reinforced half body ply 340 and second fiber-reinforced half body ply 345 may comprise a reinforcement cord and rubber skim.

In one embodiment, tire 300 comprises a belt 350. In another embodiment, tire 300 comprises a plurality of belts 350. Belt 350 may be oriented in crown portion 315 of tire 300. In one embodiment, belt 350 comprises a first belt edge 355 and a second belt edge 360.

In one embodiment, first fiber-reinforced half body ply 340 extends about first bead portion 320, along first sidewall 305, and terminates inside of first belt edge 355. In another embodiment, second fiber-reinforced half body ply 345 extends about second bead portion 325, along second sidewall 310, and terminates inside of second belt edge 360.

In one embodiment, first fiber-reinforced half body ply 340 comprises a first turnup portion 365 defined by the portion of first fiber-reinforced half body ply 340 extending about first bead portion 320. In another embodiment, second fiber-reinforced half body ply 345 comprises a second turnup portion 370 defined by the portion of second fiber-reinforced half body ply 345 extending about second bead portion 325.

In one embodiment, a third fiber-reinforced half body ply 375 extends from above bead portion 320, along first sidewall 305, and terminates inside of first belt edge 355. In another embodiment, a fourth fiber-reinforced half body ply 380 extends from above bead portion 325, along second sidewall 310, and terminates inside of second belt edge 360. In one embodiment, at least one of third fiber-reinforced half body ply 375 and fourth fiber-reinforced half body ply 380 extends from below bead portions 320 and 325. In one embodiment, at least one of third fiber-reinforced half body ply 375 and fourth fiber-reinforced half body ply 380 are oriented radially outwardly of first fiber-reinforced half body ply 340 and second fiber-reinforced half body ply 345. In one embodiment, first fiber-reinforced half body ply 340, second fiber-reinforced half body ply 345, third fiber-reinforced half body ply 375, and fourth fiber-reinforced half body ply 380 are oriented radially inwardly of belt 350.

In one embodiment, tire 300 comprises a centerline CL oriented at the laterally central point within tire 300. Centerline CL may correspond with the centerline of a rim.

In one embodiment, first fiber-reinforced half body ply 340 terminates at a point that is a distance D1 from centerline CL. In another embodiment, second fiber-reinforced half body ply 345 terminates at a point that is a distance D2 from centerline CL. In another embodiment, third fiber-reinforced half body ply 375 terminates at a point that is a distance D1 from centerline CL. In another embodiment, fourth fiber-reinforced half body ply 380 terminates at a point that is a distance D2 from centerline CL.

In one embodiment, first belt edge 355 extends to a distance B1 from centerline CL. In another embodiment, second belt edge 360 extends to a distance B2 from centerline CL. In one embodiment, distance B1 and distance B2 are greater than distance D1 and distance D2.

In one embodiment, tire 300 comprises a cut-out zone in crown portion 315. In one embodiment, no fiber-reinforced material extends through the cut-out zone, including any body ply or reinforcing ply. In another embodiment, no reinforcement material extends through the cut-out zone.

FIG. 4 illustrates a cross-sectional view of a tire 400 having a prior art construction. Tire 400 consists essentially of a first sidewall 405, a second sidewall 410, a crown portion 415, a first side 430, a second side 435, a first bead portion 420, and a second bead portion 425.

As shown, tire 400 has a body ply 440. Body ply 440 extends about first bead portion 455, along sidewall 405 in first side 430, across crown portion 415, along sidewall 410 in second side 435, and about second bead portion 425. As shown, body ply 440 has a first turnup portion 445 defined by the portion of body ply 440 extending about first bead portion 420. Body ply 440 also has a second turnup portion 447 defined by the portion of body ply 440 extending about second bead portion 425. As shown, tire 400 has at least one belt 450.

As illustrated in FIG. 4, body ply 440 extends across the width of tire 400 without a cut-out zone.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A pneumatic tire, comprising:
at least one belt oriented in a crown portion of the tire, the at least one belt comprising a first belt edge and a second belt edge;
a first bead portion;
a second bead portion;
a first sidewall;
a second sidewall;
a first fiber-reinforced half body ply extending about the first bead portion, along the first sidewall, and terminating inside of the first belt edge;
a second fiber-reinforced half body ply extending about the second bead portion, along the second sidewall, and terminating inside of the second belt edge; and
a cut-out zone in the crown portion of the tire,
with the caveat that no fiber-reinforced material extends through the cut-out zone.

2. The pneumatic tire of claim 1, wherein the tire comprises a centerline CL;
and wherein the first fiber-reinforced half body ply terminates at a point that is a distance D1 from centerline CL;
and wherein the second fiber-reinforced half body ply terminates at a point that is a distance D2 from centerline CL;
and wherein the first belt edge extends to a distance B1 from centerline CL;
and wherein the second belt edge extends to a distance B2 from centerline CL; and
and wherein the distance B1 is greater than the distance D1 and the distance B2 is greater than the distance D2.

3. The pneumatic tire of claim 2, wherein distance B1 and distance B2 are up to about 3.0 in. greater than distance D1 and distance D2.

4. The pneumatic tire of claim 1, further comprising a third fiber-reinforced half body ply extending about the first bead portion, along the first sidewall, and terminating inside of the first belt edge.

5. The pneumatic tire of claim 1, further comprising a fourth fiber-reinforced half body ply extending about the second bead portion, along the second sidewall, and terminating inside of the second belt edge.

6. The pneumatic tire of claim 1, further comprising a third fiber-reinforced half body ply extending from above the first bead portion, along the first sidewall, and terminating inside of the first belt edge.

7. The pneumatic tire of claim 1, further comprising a fourth fiber-reinforced half body ply extending from above the second bead portion, along the second sidewall, and terminating inside of the second belt edge.

8. The pneumatic tire of claim 1, wherein the first fiber-reinforced half body ply and the second fiber-reinforced half body ply are oriented radially inwardly of the belt.

9. A pneumatic tire, comprising:
at least one belt oriented in a crown portion of the tire, the at least one belt comprising a first belt edge and a second belt edge;
a first bead portion;
a second bead portion;
a first sidewall;
a second sidewall;
a first fiber-reinforced half body ply extending about the first bead portion, along the first sidewall, and terminating inside of the first belt edge;
a second fiber-reinforced half body ply extending about the second bead portion, along the second sidewall, and terminating inside of the second belt edge;
a third fiber-reinforced half body ply extending from above the first bead portion, along the first sidewall, and terminating inside of the first belt edge; and
a fourth fiber-reinforced half body ply extending from above the second bead portion, along the second sidewall, and terminating inside of the second belt edge.

10. The pneumatic tire of claim 9, further comprising a cut-out zone in the crown portion of the tire, with the caveat that no fiber-reinforced material extends through the cut-out zone.

11. The pneumatic tire of claim 9, wherein the third fiber-reinforced half body ply is oriented radially outwardly of the first fiber-reinforced half body ply.

12. The pneumatic tire of claim 9, wherein the fourth fiber-reinforced half body ply is oriented radially outwardly of the second fiber-reinforced half body ply.

13. The pneumatic tire of claim 9, wherein the tire comprises a centerline CL;
and wherein the first fiber-reinforced half body ply terminates at a point that is a distance D1 from centerline CL;
and wherein the second fiber-reinforced half body ply terminates at a point that is a distance D2 from centerline CL;
and wherein the first belt edge extends to a distance B1 from centerline CL;
and wherein the second belt edge extends to a distance B2 from centerline CL; and
and wherein the distance B1 is greater than the distance D1 and the distance B2 is greater than the distance D2.

14. The pneumatic tire of claim 13, wherein distance B1 and distance B2 are up to about 3.0 in. greater than distance D1 and distance D2.

15. The pneumatic tire of claim 9, wherein the first fiber-reinforced half body ply, the second fiber-reinforced half body ply, the third fiber-reinforced half body ply, and the fourth fiber-reinforced half body ply are oriented radially inwardly of the belt.

16. A pneumatic tire, comprising:
at least one belt oriented in a crown portion of the tire, the at least one belt comprising a first belt edge and a second belt edge;
a first bead portion;
a second bead portion;
a first sidewall;
a second sidewall;
a first fiber-reinforced half body ply extending from inside of the first belt edge, along the first sidewall, about the first bead portion, along the first sidewall, and terminating inside of the first belt edge;
a second fiber-reinforced half body ply extending from inside of the second belt edge, along the second sidewall, about the second bead portion, along the second sidewall, and terminating inside of the second belt edge; and
a cut-out zone in the crown portion of the tire,
with the caveat that no fiber-reinforced material extends through the cut-out zone.

17. The pneumatic tire of claim 16, wherein the tire comprises a centerline CL;
wherein the first fiber-reinforced half body ply begins or terminates at a point that is a distance D1 from centerline CL;
wherein the second fiber-reinforced half body ply begins or terminates at a point that is a distance D2 from centerline CL;
wherein the first belt edge extends to a distance B1 from centerline CL;
wherein the second belt edge extends to a distance B2 from centerline CL; and
wherein the distance B1 is greater than the distance D1 and the distance B2 is greater than the distance D2.

18. The pneumatic tire of claim 17, wherein distance B1 and distance B2 are up to about 3.0 in. greater than distance D1 and distance D2.

19. The pneumatic tire of claim 16, wherein the first fiber-reinforced half body ply and the second fiber-reinforced half body ply are oriented radially inwardly of the belt.

20. The pneumatic tire of claim 16, further comprising a third fiber-reinforced half body ply extending about the first bead portion, along the first sidewall, and terminating inside of the first belt edge and a fourth fiber-reinforced half body ply extending about the second bead portion, along the second sidewall, and terminating inside of the second belt edge.
